(19) United States
(12) Patent Application Publication
(10) Pub. No.: US 2004/0178191 A1
(43) Pub. Date: Sep. 16, 2004

(54) Method for manufacturing magnetic tape and magnetic tape

(75) Inventors: Naoto Yajima, Tokyo (JP); Akihiko Seki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 10/790,017

(22) Filed: Mar. 2, 2004

(30) Foreign Application Priority Data
Mar. 14, 2003 (JP) 2003-069266

(51) Int. Cl. G03B 23/02

(52) U.S. Cl. 219/645

(57) ABSTRACT

The present invention provides a method for manufacturing a magnetic tape having a predetermined curvature, specifically, a high-capacity linear-recording magnetic tape excellent in linear running characteristics in a linear tape drive. The present invention provides a high-capacity linear-recording magnetic tape excellent in linear running characteristics in the linear tape drive. The present invention is a method for manufacturing a magnetic tape comprising the steps of winding a magnetic tape having a predetermined width around a tape-curving hub 8 having a tape winding surface 8a formed in a tapered shape, and holding the magnetic tape at a temperature of 40 to 60° C. during a predetermined time in the state where the magnetic tape is wound around the tape-curving hub 8 to obtain a predetermined curvature.

### BACKGROUND OF THE INVENTION

1. Field of the Invention

The present invention relates to a method for manufacturing a magnetic tape having a predetermined curvature and, more specifically, to a manufacturing method of a high-capacity linear-recording magnetic tape excellent in linear running characteristics in a linear tape drive. The present invention also relates to the high-capacity linear-recording magnetic tape excellent in the linear running characteristics in the linear tape drive.

2. Disclosure of the Related Art

Of magnetic tapes with various uses, a linear-recording magnetic tape should particularly have linear running characteristics in a linear tape drive. Particularly in recent years, the field of linear-recording magnetic tapes for data-backup has been involved in enlargement of computer hard disk capacity for backup, and some commercially available products have a recording capacity of 100 GB or more per reel. Such tapes also have a short recording wavelength and a narrow track width for high recording density. From now on, the capacity of the linear-recording magnetic tape for data-backup should be made larger, and therefore higher accuracy should be required of the linear running characteristics in order to be suitable for a narrower track width.

Conventionally, the magnetic tape is manufactured as follows. First, a magnetic layer is formed on one side of a wide non-magnetic support made of synthetic resin, and a back coat layer is formed on the other side thereof. Then, the resultant laminate is wound around a roll, thereby forming a magnetic tape web. Thereafter, while unreeling the magnetic tape web from the roll, the magnetic tape is slit to form a plurality of magnetic tapes each having a thin strip shape. Each magnetic tape formed by slitting is wound around a tape hub using a winding unit.

The tape roll (so-called pancake) comprising the hub and the tape wound around it can be a commercial product as it is or can be subjected to a subsequent process in which the tape roll is contained in a cassette case to form another commercial product, a cassette tape. In such a tape roll, however, the tape cannot have good linear-running characteristics.

Regarding helical scan type magnetic tapes, not including any linear-recording magnetic tape, Japanese Laid-open Patent Application Nos. 9-138945 (1997) and 9-198653 (1997) disclose a process of winding a tape around a hub having a tape winding surface which is formed in a tapered shape and has a taper angle of 10′ to 1°, and holding the tape during a predetermined time in the state where the tape is wound around the hub, thereby curving the tape.

In the technique disclosed in the above publications, however, the tape only has a small curvature, and such a curvature dissipates with lapse of time. Thus, there has been a demand for a technique for attaining better curvature of the tape.

### SUMMARY OF THE INVENTION

It is therefore an object of the present invention to provide a manufacturing method of a magnetic tape having a predetermined curvature and, particularly, a high-capacity linear-recording magnetic tape excellent in linear running characteristics in a linear tape drive. It is another object of the present invention to provide the high-capacity linear-recording magnetic tape excellent in the linear running characteristics in the linear tape drive.

A tape reel in the state where a tape is wound regularly around a reel in a cassette case can exhibit good linear-running characteristics. A typical reel contained in a cassette case has upper and lower flanges. For the purpose of providing a good shape of winding, it should be advantageous to wind the tape along one of the upper and lower flanges. If the tape is curved along the longitudinal direction, it can regularly be wound along one of the upper and lower flanges.

In a typical linear-recording tape, a magnetic layer or a back coat layer has tens to hundreds of tracks which are provided parallel in the width direction and extend along the longitudinal direction. On such tracks, servo signals are recorded. The positions of such tracks in the width direction are each determined by the distance from one edge called reference edge. If the tape is regularly wound along the flange on the reference edge side, therefore, the linear-running characteristics and the servo characteristics can be improved. If the liner-running characteristics decrease with the servo characteristics, it can be hard to read the recorded data, so that the error rate can be increased.

For the purpose of regularly winding the tape along the flange on the reference edge side, the reference side edge should be moderately shorter in length than the other side edge; namely, the tape should have a moderate curvature along the longitudinal direction.

The present invention is a method for manufacturing a magnetic tape comprising the steps of: winding a magnetic tape having a predetermined width around a tape-curving hub having a tape winding surface formed in a tapered shape; and holding the magnetic tape at a temperature of 40 to 60° C. during a predetermined time in the state where the magnetic tape is wound around the tape-curving hub to obtain a predetermined curvature. The magnetic tape, having a predetermined width, to be treated is a strip slit from a magnetic tape web to be a determined width.

The present invention is the method for manufacturing a magnetic tape, wherein the magnetic tape is held at a temperature of 40 to 60° C. during a time of 10 hours or more and less than 72 hours in the state where the magnetic tape is wound around the tape-curving hub.

The present invention is the method for manufacturing a magnetic tape, wherein the magnetic tape has a curvature of 1 to 5 mm per 1 m of the tape.

The present invention is the method for manufacturing a magnetic tape, wherein the magnetic tape comprises a magnetic layer having a thickness of 0.3 μm or less.

The present invention is the method for manufacturing a magnetic tape, wherein the magnetic tape is a linear-recording tape.

The present invention provides a linear-recording magnetic tape having an edge on a reference edge side shorter in length than that on the other side.

The present invention provides the linear-recording magnetic tape, wherein the magnetic tape has a curvature of 1 to 5 mm per 1 m of the tape.

The present invention provides the linear-recording magnetic tape, wherein the magnetic tape comprises a magnetic layer having a thickness of 0.3 μm or less.

In the present invention, the curvature of the tape may be defined according to SMPT (Society of Motion Picture and Television). Specifically, the curvature may be defined as follows. Referring to FIG. 1(a), a tape 1 is placed on a flat surface. Any two points A and B on the lower edge 1a of the tape 1 are taken, which are 1 m distant from each other. The maximum distance t₁ between the lower edge 1a and the reference line passing through points A and B is defined as the curvature. If the running direction of the tape 1 is taken into account, the curvature may be defined as follows. In the case where the tape 1 runs as shown in FIG. 1(a) in the right-to-left direction indicated by the arrow, the curvature is determined as shown above. In the case where the tape 1 runs as shown in FIG. 1(b) in the right-to-left direction indicated by the arrow, the maximum distance t₂ between the upper edge 1b and the reference line passing through points A and B is defined as the curvature, wherein points A and B are any points on the upper edge 1b of the tape 1 and 1 m distant from each other. For the sake of convenience, the curvature t₁ shown in FIG. 1(a) is defined as positive (+), and the curvature t₂ shown in FIG. 1(b) is defined as negative (−).

### BRIEF DESCRIPTION OF THE DRAWINGS

FIG. 1 is a diagram showing the curvature of the magnetic tape.

FIG. 2 is a diagram showing magnetic tape winding processes in the present inventive method.

FIG. 3 is a perspective view showing an example of a tape-curving hub for use in the present inventive method.

FIG. 4 is a cross-sectional view showing an example of the tape-curving hub for use in the present inventive method and including its rotational axis line C.

FIG. 5 is a cross-sectional view showing another example of the tape-curving hub for use in the present inventive method and including its rotational axis line C.

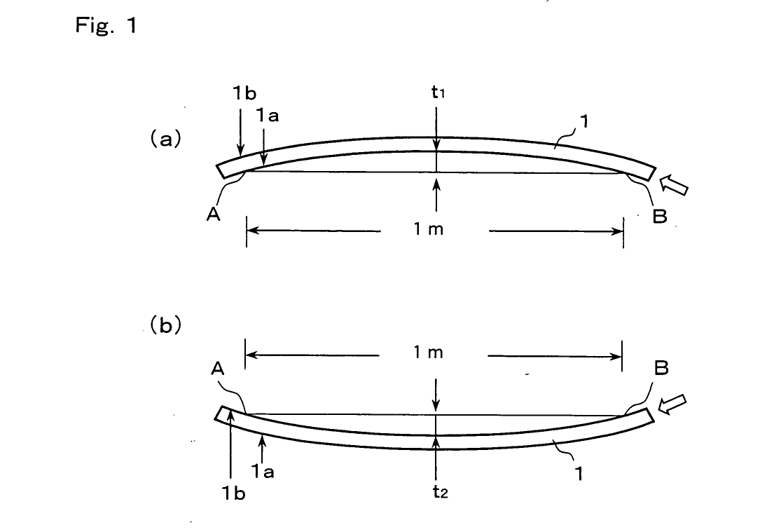

### DETAILED DESCRIPTION OF THE INVENTION

A magnetic tape according to the present inventive method is manufactured as follows. First, a magnetic layer is formed on one side of a wide non-magnetic support made of synthetic resin. Preferably, a non-magnetic layer and the magnetic layer are formed in this order on one side of the non-magnetic support. A back coat layer is formed on the other side of the non-magnetic support. The resultant laminate is wound in the form of a roll, thereby forming a wide magnetic tape web (the magnetic tape web wound in the form of a roll is referred to as a so-called jumbo roll). The back coat layer may be formed after or before the formation of the non-magnetic layer and the magnetic layer.

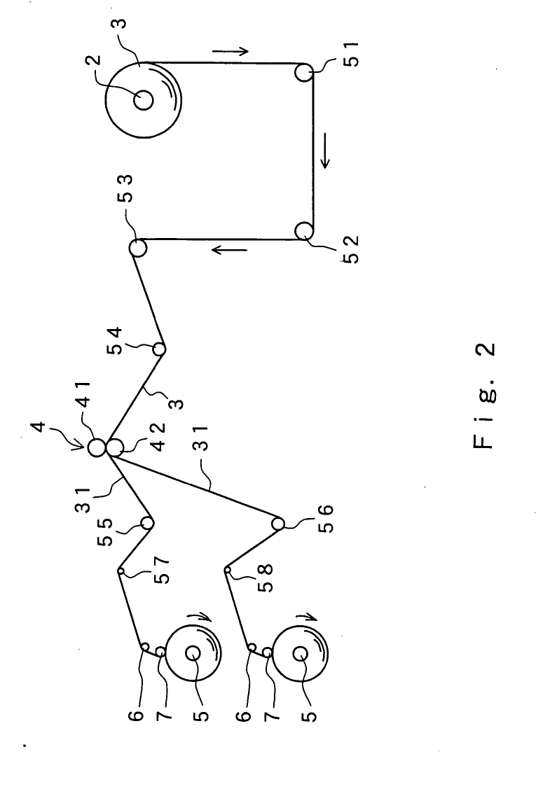

While unreeling the magnetic tape web from the jumbo roll, the magnetic tape web is slit to form a plurality of magnetic tapes each having a predetermined width. Each magnetic tape formed by slitting is wound around a tape hub using a winding machine. Referring to FIG. 2, brief description will be given of a series of magnetic tape winding processes.

Referring to FIG. 2, a magnetic tape winding machine comprises: an unreeling roller 2 which unreels a magnetic tape web 3 to be slit; a slitter 4 which slits the unreeled magnetic tape web 3 at a predetermined width; winding hubs 5 which wind up magnetic tapes 31 formed by slitting; touch rollers 7 and guide rollers 6 provided on the upper stream side of the touch rollers 7, each of which guides and feeds the magnetic tape 31 into the winding hub 5 and, also, regulates the winding state of the magnetic tape 31; and guide rollers 51, 52, 53, 54, 55, 56, 57 and 58 which are appropriately provided. For example, the winding hubs 5 are placed at two stages in a vertical direction.

The magnetic tape web 3 unreeled from the unreeling roller 2 is slit by the slitter 4 having an upper rotary blade 41 and a lower rotary blade 42, so that a plurality of magnetic tapes are continuously formed in the form of a thin strip at a predetermined width. The magnetic tapes 31 formed by slitting are wound around the winding hubs 5, respectively.

In an embodiment of the present invention, a tape-curving hub, which has a tape winding surface formed in a tapered shape, is used as the winding hub 5. Next, description will be given of such a hub.

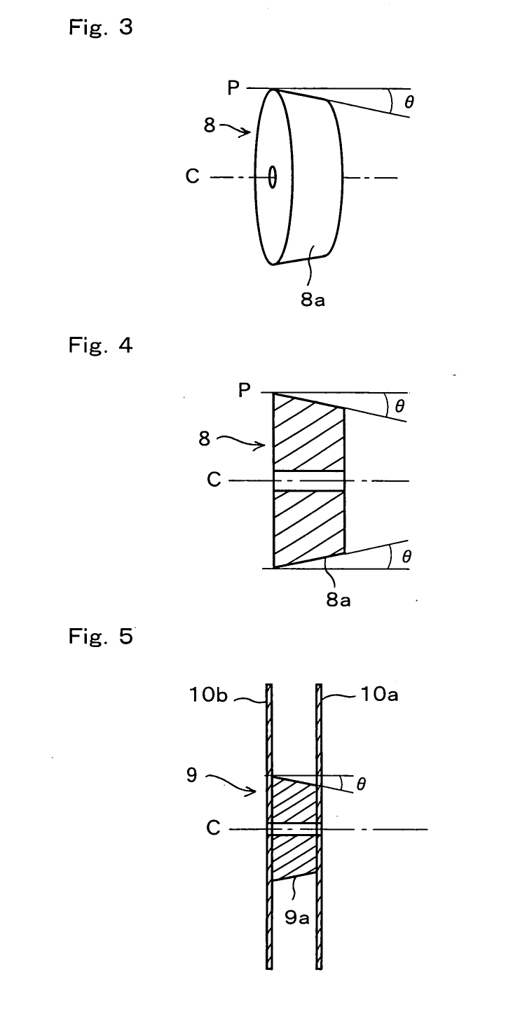

FIG. 3 is a perspective view of the tape-curving hub, and FIG. 4 is a cross-sectional view of the hub along its rotational axis line C.

Referring FIGS. 3 and 4, the tape-curving hub 8 has a tape winding surface 8a formed in a tapered shape. Specifically, the diameter of the hub 8 continuously changes from one end side to the other end side in the direction of the rotational axis line C so that the tape winding surface 8a is formed in a tapered shape. The taper angle is represented by a tilt angle θ, which the tape winding surface 8a forms with a straight line P parallel to the rotational axis line C.

FIG. 5 is a cross-sectional view of a tape-curving hub 9, having flanges 10a and 10b, in which its rotational axis line C is included. Similarly to the hub 8, the hub 9 has a tape winding surface 9a formed in a tapered shape.

The tape-curving hub 8 is used as the winding hub 5, and the magnetic tape 31 formed by slitting is wound around the hub 8. Then, the magnetic tape 31 is held at a temperature of 40 to 60° C. during a predetermined time in the state where the magnetic tape 31 is wound around the hub 8. As a result, the magnetic tape 31 is curved depending on the tilt degree (taper angle) of the tape winding surface 8a. Specifically, referring to FIG. 4, the circumference of the tape winding surface 8a on its left side is larger than that of the tape winding surface 8a on its right side; therefore, the edge of the wound magnetic tape 31 on its left side is stretched rather than that of the magnetic tape 31 on its right side under the above temperature condition. As a result, the magnetic tape 31 is curved. When the tape-curving hub 9 is used, the magnetic tape 31 is curved similarly.

It is herein important that the magnetic tape 31 is held under the temperature condition of 40 to 60° C. in the state where the magnetic tape 31 is wound around the tape-curving hub 8. The holding of the magnetic tape wound around the tape-curving hub with the same taper angle under the temperature in such a range can attain larger curvature. Thereafter, the resulting curvature is less reduced over time. Thus, a tape-curving hub, having a smaller taper angle, may be used to attain a similar tape curvature without harmful effects such as wrinkling of the tape. In addition, the holding time can be shortened. If the magnetic tape is held at a temperature less than 40° C., for example, at room temperature such as about 25° C. in the state where the magnetic tape is wound around the tape-curving hub 8, only a small tape curvature can be attained even when a tape-curving hub, having the same taper angle, is used. Further, the resulting curvature can easily be lost over time. On the other hand, if the holding is performed at a high temperature exceeding 60° C., the curvature can easily be attained, but the surface roughness of the back coat layer is possibly transferred to the surface of the magnetic layer, so that the error rate is increased.

The holding may be performed at any humidity, but preferably at a relative humidity up to 80%, for example, 10 to 80%, more preferably at a relative humidity of 10 to 50%. At a relative humidity exceeding 80%, the non-magnetic support film swells; therefore, the wound tape shifts in the tape width direction in a stepped manner in some cases when the film shrinks. If the wound tape causes such shifting, the tape cannot be placed on the winding machine in a subsequent process. A higher relative humidity can attain a larger tape curvature but can cause a transfer of the surface roughness of the back coat layer to the surface of the magnetic layer, so that the error rate is increased. On the other hand, there is no inconvenience in terms of the performance of the tape even when the holding is performed at a relative humidity of less than 10%, but such a relative humidity of less than 10% is hard to control.

The magnetic tape is preferably held during a time of 10 hours or more and less than 72 hours, more preferably during a time of 10 hours or more and 48 hours or less, under the above temperature condition in the state where the magnetic tape is wound around the tape-curving hub 8. It can be hard to attain an appropriate curvature during a time shorter than 10 hours. A holding time of 72 hours or more may not attain a further increase in the curvature and, therefore, is not preferred in terms of production efficiency. In the inventive method, the magnetic tape is held at a temperature of 40 to 60° C. in the state where the magnetic tape is wound around the tape-curving hub 8; therefore, the desired tape curvature can be attained using a holding time of less than 72 hours, for example, 24 hours.

Appropriate tape curvatures depend on the use of the magnetic tape. For example, a curvature of 1 to 5 mm per 1 m of the tape is appropriate for the linear-recording magnetic tape. In a preferred mode, the curvature is formed in such a manner that the edge on the reference edge side is shorter in length than that of the other edge side. The tape with a curvature in such a range can be easily regularly wound on a reel in a cassette case when forming a tape roll, and can have excellent linear-running characteristics. If the tape curvature is less than 1 mm, the tape roll can easily have irregularities. If the tape curvature exceeds 5 mm, the tape can be in hard contact with the flange of the reel, so that the tape edge can easily be damaged. In such a case, the tape roll can also have irregularities.

Thus, the tape is curved. Thereafter, the magnetic tape is unreeled from the tape-curving hub 8 and is regularly wound around a reel having flanges, and the resulting tape roll is contained in a cassette case.

In another embodiment of the present invention, a hub having a normal tape winding surface (i.e., a taper angle of 0°) may be used as the winding hub 5. In such a case, the tape is not curved at this stage. The magnetic tape is then unreeled from the normal hub and is wound around the tape-curving hub 8 or 9. The magnetic tape is then held at a temperature of 40 to 60° C. during a predetermined time in the state where the magnetic tape is wound around the tape-curving hub 8 or 9, so that the magnetic tape is curved. Generally, the magnetic tape is then unreeled from the tape-curving hub 8 and is regularly wound around a reel having flanges, and the resulting tape roll is contained in a cassette case.

When the magnetic tape is held at a predetermined temperature during a predetermined time in the state where the magnetic tape is wound around the tape-curving hub, the tape curvature can tend to be relatively large at an inner site closer to the hub and relatively small at an outer site more distant from the hub. Therefore, the magnetic tape curved by being held in the state where it is wound around the tape-curving hub is unreeled from the tape-curving hub and, then, is re-wound around another tape-curving hub and held at a predetermined temperature during a predetermined time. Such a process can offset the difference in curvature between the inner site and the outer site.

The manufacturing method of the magnetic tape is suitable for manufacturing a linear-recording tape with a high recording density, comprising a thin film magnetic layer having a thickness of 0.3 μm or less, preferably 0.05 to 0.30 μm, more preferably 0.10 to 0.25 μm. When the magnetic layer is too thick, self-demagnetization loss and thickness loss are made larger.

### EXAMPLES

Hereinafter, the present invention will be further described in detail with reference to examples, but the present invention is not limited to the examples.

### Example 1

<Preparation of a coating material for lower non-magnetic
layer>
(Preparation of binder solution)

| | |
|---|---|
| Electron beam curing type vinyl chloride resin NV 30 wt % | 45 parts by mass |
| (copolymer of vinyl chloride-epoxy-containing monomer, mean | |
| degree of polymerization = 310, epoxy content = 3 wt %, S | |
| content = 0.6 wt %, acrylic content = 6 pcs/1 molecule, Tg = 60° C.) | |
| Electron beam curing type polyester polyurethane resin NV | 16 parts by mass |
| 40 wt % | |
| (polar group —OSO₃Na-containing polyester polyurethane, | |
| number-average molecular weight = 26000) | |
| Methyl ethyl ketone (MEK) | 2 parts by mass |
| Toluene | 2 parts by mass |
| Cyclohexanone | 2 parts by mass |

The above compositions were placed in a hyper mixer and agitated to prepare a binder solution.

(Kneading)

The following compositions were placed in a pressing kneader and kneaded for 2 hours.

| | |
|---|---|
| Acicular α-Fe₂O₃ | 85 parts by mass |
| (DB-65 made by Toda Kogyo Corp., | |
| average major axis length = 0.11 μm, | |
| BET (specific surface area) = 53 m²/g) | |
| Carbon black | 15 parts by mass |
| (#850B made by Mitsubishi Chemical Corp., average | |
| particle diameter = 16 nm, | |
| BET = 200 m²/g, DPB | |
| oil absorption = 70 ml/100 g) | |
| α-Al₂O₃ | 5 parts by mass |
| (HIT-60A made by Sumitomo Chemical Co., Ltd., | |
| average particle diameter = 0.20 μm) | |
| O-phthalic acid | 2 parts by mass |
| Binder solution | 67 parts by mass |

After the kneading, the resulting slurry was mixed with the following compositions so as to have an optimal viscosity for dispersion treatment.

| | |
|---|---|
| MEK | 40 parts by mass |
| Toluene | 40 parts by mass |
| Cyclohexanone | 40 parts by mass |

(Dispersion)

The slurry was subjected to dispersion treatment in a horizontal type pin mill 75% filled with zirconia beads (TORAYCERAM made by Toray Industries, Inc., φ=0.8 mm).

(Viscosity Modifier Liquid)

The following compositions were placed in a hyper mixer and agitated to prepare a viscosity modifier liquid.

| | |
|---|---|
| Stearic acid | 1 part by mass |
| Butyl stearate | 1 part by mass |
| MEK | 30 parts by mass |
| Toluene | 30 parts by mass |
| Cyclohexanone | 30 parts by mass |

(Viscosity Control and Final Coating Material)

After the dispersion treatment, the slurry was mixed with the above solution and agitated, and the resulting mixture was subjected to the dispersion treatment again in the horizontal type pin mill 75% filled with zirconia beads (TORAYCERAM made by Toray Industries, Inc., φ=0.8 mm) to prepare a coating material. The resulting coating material was subjected to circulating filtration using a depth filter with an absolute filtration accuracy of 1.0 μm, giving a final coating material for the lower non-magnetic layer.

<Preparation of coating material for magnetic layer>
(Preparation of binder solution)

| | |
|---|---|
| Vinyl chloride type resin | 11 parts by mass |
| (MR-110 made by Nippon Zeon Co., Ltd.) | |
| Polyester polyurethane resin NV 30 wt % | 17 parts by mass |
| (UR-8300 made by Toyobo Co., Ltd.) | |
| MEK | 7 parts by mass |
| Toluene | 7 parts by mass |
| Cyclohexanone | 7 parts by mass |

The above compositions were placed in a hyper mixer, mixed and agitated to prepare a binder solution.

(Kneading)

The following compositions were placed in a pressing kneader and kneaded for 2 hours.

| | |
|---|---|
| α-Fe magnetic powder | 100 parts by mass |
| (Hc = 1885 Oe, Co/Fe = 20 (atomic ratio), | |
| σs = 138 emu/g, BET = 58 m²/g, | |
| average major axis length = 0.10 μm) | |
| α-Al₂O₃ | 6 parts by mass |
| (HIT-60A made by Sumitomo Chemical Co., Ltd., | |
| average particle diameter = 0.20 μm) | |
| α-Al₂O₃ | 6 parts by mass |
| (HIT-82 made by Sumitomo Chemical Co., Ltd., | |
| average particle diameter = 0.13 μm) | |
| Phosphate ester | 2 parts by mass |
| (PHOSPHANOL RE610 made by Toho Chemical | |
| Industry Co., Ltd.) | |
| Binder solution | 49 parts by mass |

After the kneading, the resulting slurry was mixed with the following compositions so as to have an optimal viscosity for dispersion treatment.

| | |
|---|---|
| MEK | 100 parts by mass |
| Toluene | 100 parts by mass |
| Cyclohexanone | 75 parts by mass |

(Dispersion)

The slurry was subjected to dispersion treatment in a horizontal type pin mill 75% filled with zirconia beads (TORAYCERAM made by Toray Industries, Inc., φ=0.8 mm).

(Viscosity Modifier Liquid)

The following compositions were placed in a hyper mixer, mixed and agitated for 1 hour to form a viscosity modifier liquid.

| | |
|---|---|
| Stearic acid | 1 part by mass |
| Butyl stearate | 1 part by mass |
| MEK | 100 parts by mass |
| Toluene | 100 parts by mass |
| Cyclohexanone | 250 parts by mass |

(Viscosity Control)

After the dispersion treatment, the slurry was mixed with the above solution and agitated, and the resulting mixture was subjected to the dispersion treatment again in the horizontal type pin mill 75% filled with zirconia beads (TORAYCERAM made by Toray Industries, Inc., φ=0.8 mm) to prepare a coating material. The resulting coating material was subjected to circulating filtration using a depth filter with an absolute filtration accuracy of 1.0 μm.

(Final Coating Material)

After the filtration, 100 parts by mass of the resulting coating material was mixed with 0.82 parts by mass of an isocyanate compound (CORONATE L made by Nippon Polyurethane Industry Co., Ltd.) and agitated, and the mixture was subjected to circulating filtration using a depth filter with an absolute filtration accuracy of 1.0 μm, resulting in a final coating material for the magnetic layer.

<Preparation of coating material for back coat layer>
(Preparation of binder solution)

| | |
|---|---|
| Nitrocellulose | 50 parts by mass |
| (BTH1/2 made by Asahi Kasei Corp.) | |
| Polyester polyurethane resin | 110 parts by mass |
| (UR-8300 made by Toyobo Co., Ltd.) | |
| MEK | 200 parts by mass |
| Toluene | 200 parts by mass |
| Cyclohexanone | 200 parts by mass |

The above compositions were placed in a hyper mixer and agitated to prepare a binder solution.

(Dispersion)

The following compositions were placed in a ball mill and dispersed for 24 hours.

| | |
|---|---|
| Carbon black | 75 parts by mass |
| (BLACK PEARLS 800 made by Cabot Corporation, | |
| average particle diameter = 17 nm, | |
| BET = 220 m²/g) | |
| Carbon black | 10 parts by mass |
| (BLACK PEARLS 130 made by Cabot Corporation, | |
| average particle diameter = 75 nm, | |
| BET = 25 m²/g) | |
| BaSO₄ | 15 parts by mass |
| (BF-20 made by Sakai Chemical Industry Co., Ltd., | |
| average particle diameter = 30 nm) | |
| Copper oleate | 5 parts by mass |
| Copper phthalocyanine | 5 parts by mass |
| α-alumina | 1 part by mass |
| (TM-DR made by TAIMEI Chemicals Co., Ltd., | |
| average particle diameter = 0.23 μm) | |
| Binder solution | 760 parts by mass |

(Viscosity Modifier Liquid)

The following compositions were placed in a hyper mixer and agitated to prepare a viscosity modifier liquid.

| | |
|---|---|
| MEK | 220 parts by mass |
| Toluene | 220 parts by mass |
| Cyclohexanone | 220 parts by mass |

(Viscosity Control)

After the dispersion treatment, the resulting slurry was mixed with the above solution and agitated, and the resulting mixture was subjected to the dispersion treatment again in the ball mill for 3 hours. The resulting coating material was subjected to circulating filtration using a depth filter with an absolute filtration accuracy of 3.0 μm.

(Final Coating Material)

After the filtration, 100 parts by mass of the resulting coating material was mixed with 1.1 parts by mass of an isocyanate compound (CORONATE L made by Nippon Polyurethane Industry Co., Ltd.) and agitated, and the mixture was subjected to circulating filtration using a depth filter with an absolute filtration accuracy of 3.0 μm, giving a back coat coating material.

<Manufacture of Magnetic Recording Tape>

The above coating material for the lower non-magnetic layer was applied to the surface of a 6.1 μm thick polyethylene terephthalate film at a production line speed of 100 m/min so as to have a dry thickness of 2.0 μm. The coating material was then dried in an oven to which hot air at 100° C. was supplied at a speed of 15 m/sec. The coated film was irradiated with a dose of 4.5 Mrad of electron rays and then wound up.

The above coating material for the magnetic layer was applied to the cured lower non-magnetic layer at a production line speed of 100 m/min so as to have a dry thickness of 0.20 μm. The coating film was subjected to magnetic field orientation treatment using a 5000 Oe solenoid, while it was in a wet state. The coating film was then dried in an oven to which hot air at 100° C. was supplied at a speed of 15 m/sec. Thereafter, the above coating material for the back coat layer was applied to the backside of the polyethylene terephthalate film so as to have a dry thickness of 0.6 μm. After the back coat layer was dried in an oven to which hot air at 100° C. was supplied at a speed of 15 m/sec, the film was wound up.

Thereafter, the coated film was calendered under the conditions of 90° C., 300 kg/cm, 10 nip, and a processing speed of 100 m/min, and then wound up. The resulting roll was kept in an oven at 60° C. for 24 hours to be cured by heat. Thus, a magnetic tape web was produced.

While the magnetic tape original was unreeled from an unreeling roller and allowed to run, it was slit to form a plurality of magnetic tapes each having a width of ½ inches (12.65 mm), and each magnetic tape was wound around a normal winding hub (taper angle of 0°).

The curvature was measured with respect to each tape wound around the winding hub with the taper angle of 0° and, then, a tape having a curvature of 0 mm (the curvature before curving the tape) was selected. The selected tape having the curvature of 0 mm was wound around a tape-curving hub, having a taper angle of 1°, under the following conditions.

(Winding Conditions for Hub for Curving Tape)

Hub: a taper angle of 1°, with no flange

Material: plastic

Diameter of hub: 114 mm

Width of hub: 18 mm

Winding tension: 60 g

Winding length: 2000 m

The tape was held under temperature and humidity conditions shown in Table 1 (60° C., 30%) for 24 hours in the state where the tape is wound around the tape-curving hub.

After the holding was completed, the tape 500 m in length was unreeled from the tape-curving hub and was immediately wound around a tape cartridge reel (a taper angle of 0°) under a tension of 60 g. Thereafter, a 1 m sample was cut from an outer portion of the roll and then measured for the curvature (the curvature immediately after curving the tape).

The tape wound around the tape cartridge reel was stored at a temperature of 25° C. and a humidity of 50% for 10 days. After such storage, a 1 m sample was cut from an outermost portion of the roll and then measured for the curvature (the curvature 10 days after curving the tape).

Thereafter, the reel was set in the cartridge, and linear-running characteristics, error rate and servo characteristics of the magnetic tape were evaluated as follows.

(Linear Running Characteristics of Tape)

In a linear tape drive, the whole length of the tape was allowed to move forward and backward at a running speed of 3 m/sec, while the running position of the tape was measured using a laser inspection machine (E32-T24S manufactured by OMRON Corporation). Evaluation was made based on the following criteria.

◯: No portion is displaced 10 μm or more in the width direction from the tape position at the start of the running.

X: Some portions are displaced 10 μm or more in the width direction from the tape position at the start of the running.

(Error Rate)

The error rate was measured through a process of writing data on all the tracks over the whole length of the tape by an MIG head (head width: 24 μl) and, then, reading the data by an MR head (head width: 14 μm). The shortest recording wavelength was 0.37 μm, and the number of the tracks was 450.

(Servo Characteristics)

The PES (Positioning Error Signal) value, the standard deviation of displacements, was calculated as an index of the displacement in the servo width direction. The PES value was obtained from servo output fluctuations, when writing and reading of the data were performed under the same conditions as in the error rate case. PES values less than 0.6 μm were determined as acceptable.

### Examples 2 to 6 and Comparative Examples 1 and 2

The same operations as those in Example 1 were carried out, except that conditions of the operation for curving the tape were changed as shown in Table 1.

TABLE 1

| | | | | | | | Comparative | Comparative |
|---|---|---|---|---|---|---|---|---|
| | Example 1 | Example 2 | Example 3 | Example 4 | Example 5 | Example 6 | Example 1 | Example 2 |
| Temperature | 60° C., 30% | 50° C., 30% | 40° C., 30% | 50° C., 50% | 50° C., 80% | 50° C., 30% | 25° C., 50% | 25° C., 50% |
| and humidity | | | | | | | | |
| conditions | | | | | | | | |
| Taper angle | 1.0° | 1.0° | 1.0° | 1.0° | 1.0° | 0.75° | 1.0° | 1.5° |
| Tape winding | 2000 | 2000 | 2000 | 2000 | 2000 | 3000 | 2000 | 500 |
| length (m) | | | | | | | | |
| Holding time | 24 hours | 24 hours | 24 hours | 24 hours | 24 hours | 24 hours | 72 hours | 72 hours |
| for curving tape | | | | | | | | |
| Curvature before | 0 | 0 | 0 | 0 | 0 | 0 | 0 | 0 |
| curving | | | | | | | | |
| tape (mm) | | | | | | | | |
| Curvature | 5.5 | 3.0 | 1.5 | 3.5 | 4.5 | 1.5 | 0.75 | 1.5 |
| immediately | | | | | | | | |
| after curving | | | | | | | | |
| tape (mm) | | | | | | | | |
| Curvature 10 | 5.0 | 2.5 | 1.0 | 3.0 | 4.0 | 1.25 | 0.0 | 0.5 |
| days after | | | | | | | | |
| curving | | | | | | | | |
| tape (mm) | | | | | | | | |
| Linear running | ◯ | ◯ | ◯ | ◯ | ◯ | ◯ | X | X |
| characteristics | | | | | | | | |
| Error rate (/MB) | 0.47 | 0.24 | 0.17 | 0.27 | 0.33 | 0.24 | 2.20 | 1.80 |
| PES (μm) | 0.34 | 0.42 | 0.49 | 0.40 | 0.37 | 0.49 | 0.65 | 0.62 |

Table 1 shows that in any of Examples 1 to 6 according to the present invention, an appropriate curvature was attained in a short holding time of 24 hours and that the curvature was less reduced and remained even after 10 days. In each example, the magnetic tape set in the cartridge had excellent linear running characteristics and a low error rate. Furthermore, the curvature even 30 days after curving the tape was almost the same as the curvature 10 days after curving the tape.

The above examples showed some methods of manufacturing linear-recording magnetic tape. However, the present invention refers to any other magnetic tapes. The foregoing examples are therefore only illustrative and should not be interpreted as restrictive, and all changes that fall within equivalence of claims are therefore intended to be embraced by the claims.

What is claimed is:

1. A method for manufacturing a magnetic tape comprising the steps of:
winding a magnetic tape having a predetermined width around a tape-curving hub having a tape winding surface formed in a tapered shape; and
holding the magnetic tape at a temperature of 40 to 60° C. during a predetermined time in the state where the magnetic tape is wound around the tape-curving hub to obtain a predetermined curvature.

2. The method according to claim 1, wherein the magnetic tape is held at a temperature of 40 to 60° C. during a time of 10 hours or more and less than 72 hours in the state where the magnetic tape is wound around the tape-curving hub.

3. The method according to claim 1, wherein the magnetic tape has a curvature of 1 to 5 mm per 1 m of the tape.

4. The method according to claim 1, wherein the magnetic tape comprises a magnetic layer having a thickness of 0.3 μm or less.

5. The method according to claim 1, wherein the magnetic tape is a linear-recording tape.

6. A linear-recording magnetic tape having an edge on a reference edge side shorter in length than that on the other side.

7. The linear-recording magnetic tape according to claim 6, wherein the magnetic tape has a curvature of 1 to 5 mm per 1 m of the tape.

8. The linear-recording magnetic tape according to claim 6, wherein the magnetic tape comprises a magnetic layer having a thickness of 0.3 μm or less.
